(19) United States
(12) Patent Application Publication
(10) Pub. No.: US 2002/0065132 A1
(43) Pub. Date: May 30, 2002

(54) Method and apparatus for creating a multi-panel video display unit gaming device

(75) Inventor: Don Stephan, Carson City, NV (US)

Correspondence Address: MERCHANT & GOULD PC, P.O. BOX 2903, MINNEAPOLIS, MN, 55402-0903, US

(73) Assignee: Innovative Gaming Corporation of America, Reno, NV

(21) Appl. No.: 09/933,940

(22) Filed: Aug. 21, 2001

Related U.S. Application Data
(62) Division of application No. 09/661,930, filed on Sep. 14, 2000.

(51) Int. Cl. A63F 13/00

(52) U.S. Cl. 463/30; 463/46; 463/47

(57) ABSTRACT

The present invention provides an apparatus for creating a computer generated video display based gaming device having a plurality of display unit in which gaming images, advertisements, and announcements are displayed to a player of the gaming device. apparatus consists of a multi-panel gaming device permits a player to operate a video-based game. The gaming system has a programmable computing system enclosed within a computer enclosure 10 having a top side and a back side. The gaming system also has a separate player wager and prize unit having a plurality of input and output devices relating to accepting wagers from the player and paying winnings to the player, the input and output devices are enclosed within the wager and prize unit. The gaming system uses a pair of vertical support members extending upward from the computer enclosure. These support members are located on either side of a plurality of video display devices and hold the sequence of video display devices in a vertical column. A player stands or sits in front of the rising sequence of video display devices to play the gaming system such that the player may easily view the sequence of images presented upon the display devices while operating the gaming system.

### TECHNICAL FIELD

This invention relates in general to a method for creating a multi-panel video display unit gaming device, and more particularly to a method and apparatus for creating a computer generated video display based gaming device having a plurality of display unit in which gaming images, advertisements, and announcements are displayed to a player of the gaming device.

### BACKGROUND

With the development of computing systems that incorporate multi media capabilities, gaming systems that provide entertainment to players and also offer opportunities to place wagers on the outcome of the games have become prevalent. Users of these gaming systems are constantly faced with a desire to both attract players interest in a particular gaming device as well as keep the attention of players so that the players continue to make wagers using the gaming device.

The owners of gaming systems typically operate gambling sessions and establishments such as casinos that also offer other attractions such as restaurants, retail establishments, and live entertainment venues. These establishments desire that the players of the gaming systems also patronize these other attractions. Multi media based computing systems offer operators of these establishments with capability to serve both of the above needs within a single gaming system.

In the past, video based gaming systems typically did not present video based information to players other than video and information associated with the playing of the particular game. This fact meant that establishments needed to use additional efforts to advertise and entice players to both play the games and to patronize the other attractions. This arrangement was an inefficient use of video display devices within video based gaming systems. As such a need existed to create gaming systems capable simultaneously displaying video images that both present a game and entice players to play a game as well as present advertisements and other announcements used to promote other attractions within a casino.

### SUMMARY

To overcome the limitations in the prior art described above, and to overcome other limitations that will become apparent upon reading and understanding the present specification, the present invention discloses a multi-panel gaming device permits a player to operate a video-based game over two or more video display devices.

A system in accordance with the principles of the present invention includes a multi-panel gaming device permits a player to operate a video-based game. The gaming system has a programmable computing system enclosed within a computer enclosure having a top side and a back side. The gaming system also has a player wager and prize unit having a plurality of input and output devices relating to accepting wagers from the player and paying winnings to the player, the input and output devices are enclosed within the wager and prize unit.

The gaming system uses a pair of vertical support members extending upward from the top side of the computer enclosure. These support members are located on either side of a plurality of video display devices and hold the sequence of video display devices in a vertical column. A player stands or sits in front of the rising sequence of video display devices to play the gaming system such that the player may easily view the sequence of images presented upon the display devices while operating the gaming system. The gaming system has two or more player display devices for presenting video images and audio sounds generated by the programmable computing system to the player.

Other embodiments of a system in accordance with the principles of the invention may include alternative or optional additional aspects. These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a perspective view of a three-panel embodiment of a multi-panel gaming device according to the present invention.

FIG. 2 illustrates a front view of a three-panel embodiment of a multi-panel gaming device according to the present invention.

FIG. 3 illustrates a top view of a three-panel embodiment of a multi-panel gaming device according to the present invention.

FIG. 4 illustrates a front view of a three-panel embodiment of a multi-panel gaming device illustrating the modular design of the gaming device having a computer enclosure and display unit and a wager and prize unit according to the present invention.

FIG. 5 illustrates a perspective view of a two-panel embodiment of a multi-panel gaming device according to the present invention.

FIG. 6 illustrates a front view of a two-panel embodiment of a multi-panel gaming device according to the present invention.

FIG. 7 illustrates a top view of a two-panel embodiment of a multi-panel gaming device according to the present invention.

FIG. 8 illustrates a front view of a two-panel embodiment of a multi-panel gaming device illustrating the modular design of the gaming device having a computer enclosure and display unit and a wager and prize unit according to the present invention.

FIG. 9 illustrates a perspective view of the wager and prize unit having a coin return hopper according to another embodiment of the present invention.

FIG. 10 illustrates a computing system used to generate the video images displayed upon the video display devices according to one embodiment of the present invention.

FIG. 11 illustrates a set of software modules executing within a computing system used to generate the video images displayed upon the video display devices according to another embodiment of the present invention.

### DETAILED DESCRIPTION

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

The present invention provides an apparatus for creating a computer generated video display based gaming device having a plurality of display unit in which gaming images, advertisements, and announcements are displayed to a player of the gaming device.

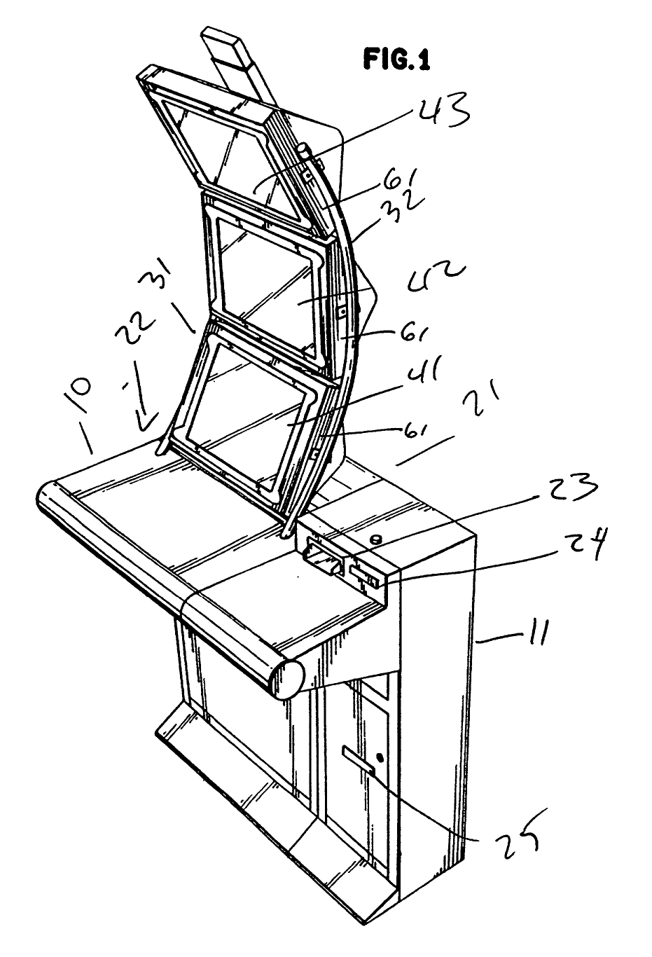

FIG. 1 illustrates a perspective view of a three-panel embodiment of a multi-panel gaming device according to the present invention. The multi-panel gaming device permits a player to operate a video-based game. The gaming system has a programmable computing system 110 enclosed within a computer enclosure 10 having a top side 22 and a back side 21. The gaming system also has a separate player wager and prize unit 11 having a plurality of input and output devices relating to accepting wagers from the player and paying winnings to the player, the input and output devices 23-25 are enclosed within the wager and prize unit 11.

The gaming system uses a pair of vertical support members 31-32 extending upward from the top side 22 of the computer enclosure 10. These support members are located on either side of a plurality of video display devices 41-43 and hold the sequence of video display devices 41-43 in a vertical column. A player stands or sits in front of the rising sequence of video display devices 41-43 to play the gaming system such that the player may easily view the sequence of images presented upon the display devices 41-43 while operating the gaming system.

The gaming system has two or more player display devices for presenting video images and audio sounds generated by the programmable computing system to the player. The video display devices 41-43 have both a pair of vertical edges and a pair of horizontal edges. The display devices 41-43 are coupled to the pair of vertical support members 31-32 about the vertical edges 61 of the video display devices.

The computer enclosure 10 and the wager and prize unit 11 are separate units electrically connected by a communication cable in order to permit the wager and prize unit 11 to be easily be connected and disconnected from the computer enclosure 10.

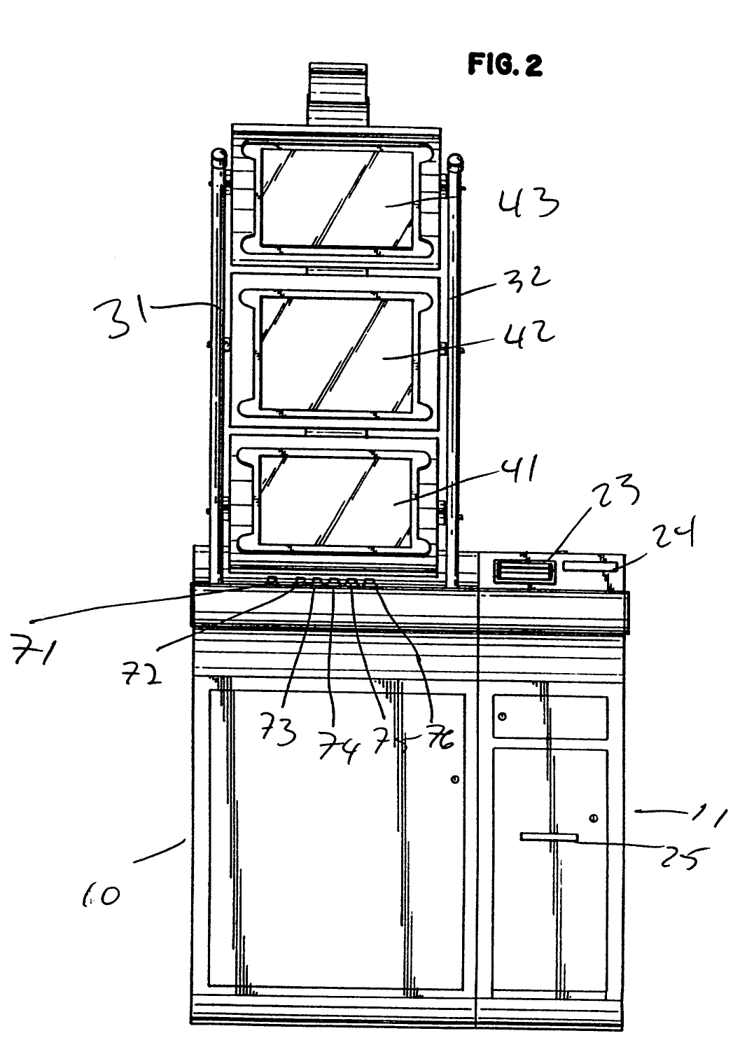

FIG. 2 illustrates a front view of a three-panel embodiment of a multi-panel gaming device according to the present invention. In the example embodiment, a plurality of user input devices 71-76 are located upon the computer enclosure. These input devices 71-76 permit a player to provide input commands and signals to the gaming system in order to initiate the playing of a game, to provide inputs needed to operate the game, and to accept other operating instructions from a player.

The gaming system has a programmable computing system 110 within the computer enclosure 10 that includes one or more concurrently operating software modules. These software modules generate a sequence of video images stored within a video interface modules for display upon the each of the video display devices 41-43. The sequence of video images correspond to video images used to display games images presenting the operation of the game to the player. The sequence of video images also correspond to video images used to display advertisements and announcements. The game images are displayed upon different video display devices 41-43 from video display devices displaying the advertisements and announcements.

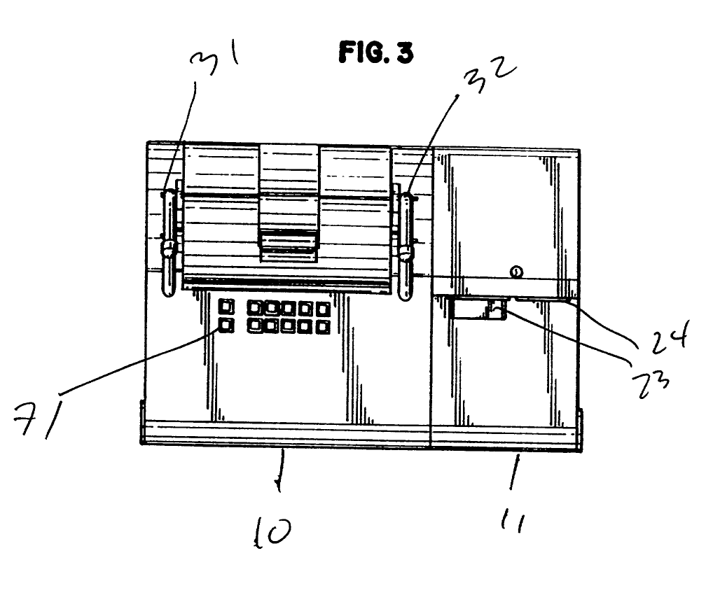

FIG. 3 illustrates a top view of a three-panel embodiment of a multi-panel gaming device according to the present invention. In one embodiment, the plurality of user input devices 71-76 located upon the computer enclosure consist of a set of individual input buttons. A player will depress a button corresponding to a desired input to start, to operate, and to end a game. One skilled in the art will recognize other user input devices such as a keyboard, a trackball, and other computer user pointing and input devices may be used in place of these buttons 71-71 without deviating from the spirit and scope of the present invention recited within the attached claims.

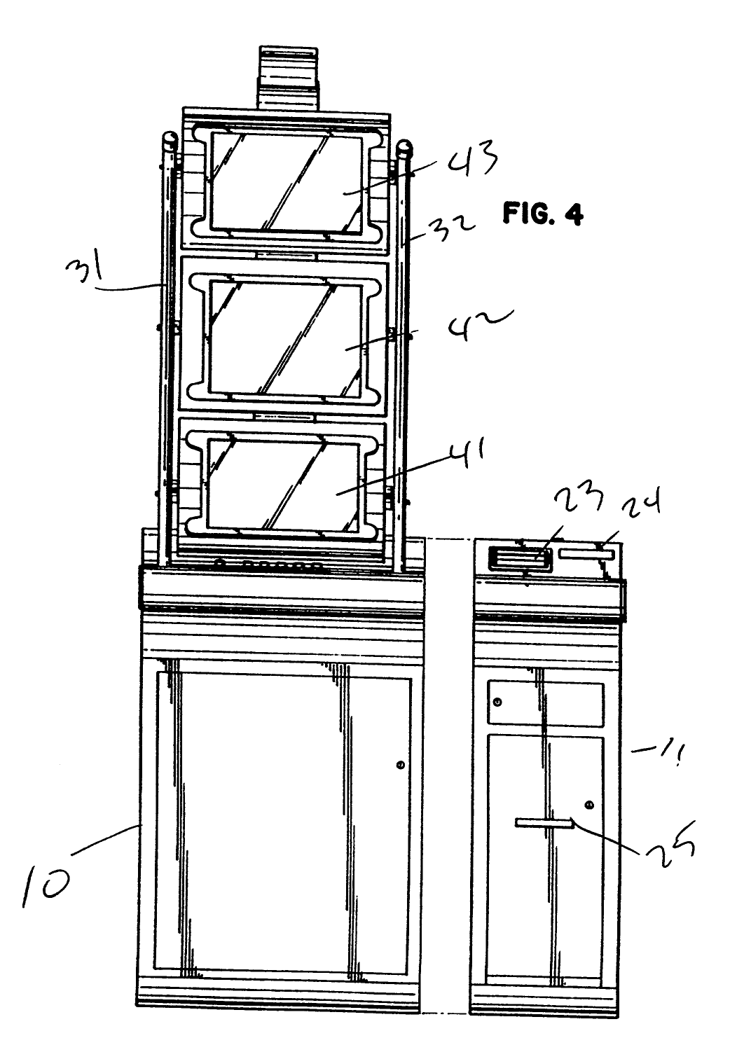

FIG. 4 illustrates a front view of a three-panel embodiment of a multi-panel gaming device illustrating the modular design of the gaming device having a computer enclosure and display unit and a wager and prize unit according to the present invention. The computer enclosure 10 and the wager and prize unit 11 are constructed from two separate units. These units are coupled together to form the gaming system used by a player. Such a construction permits a computer enclosure 10 and its computing system to be used in one embodiment where wager on the outcome of a play of a game are permitted. This same enclosure 10 and computing system 110 may also be easily reconfigured to use only tokens and award prize tickets in place of currency when the placement of a wager is not permitted simply by replacing one version of the wager and prize unit 11 for a second version of the wager and prize unit 11.

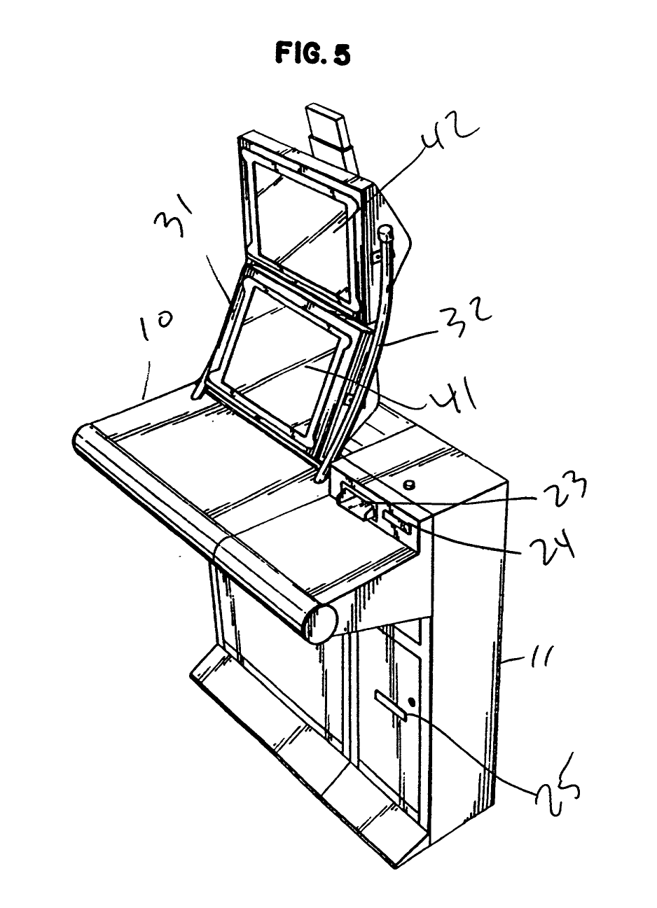

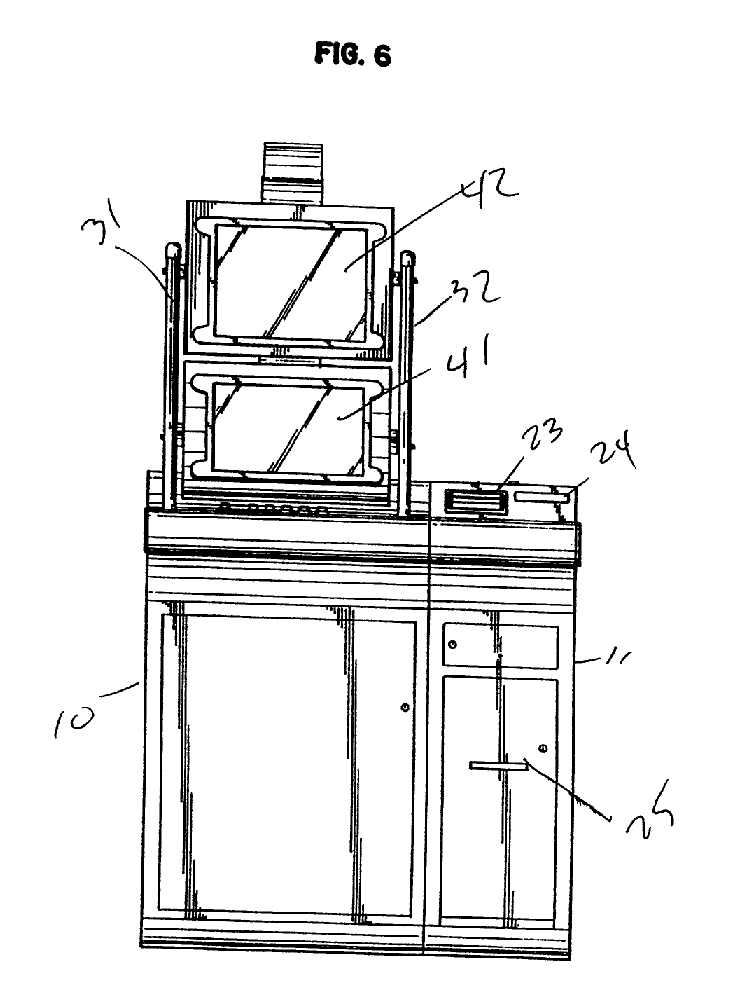

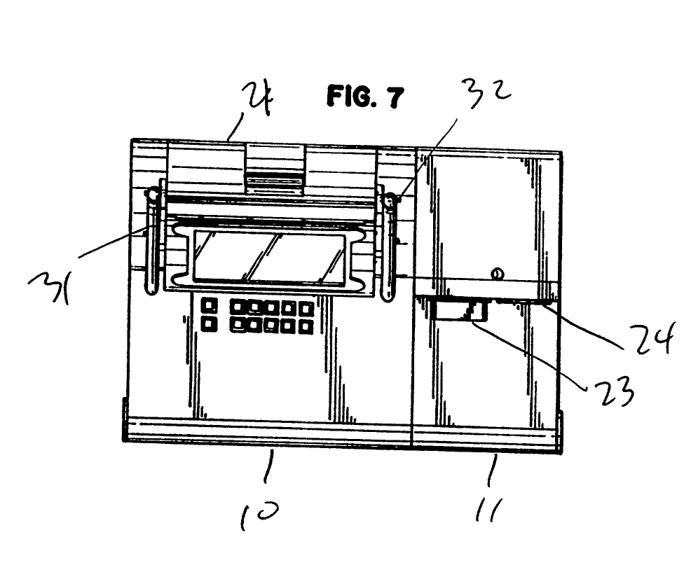

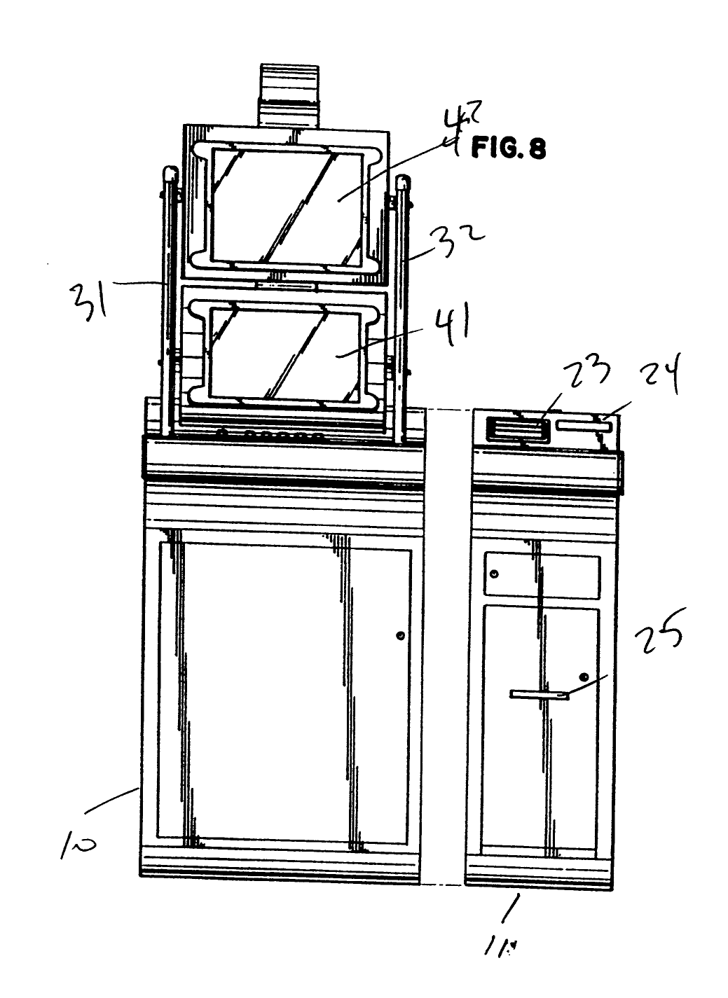

FIGS. 5-8 illustrates a set of views of a two-panel embodiment of a multi-panel gaming device according to the present invention. The gaming system may be constructed using any number of video display units 41-42 arranged in a vertical arc that permits a player to simultaneously view each of the video display units 41-42. The same games may be played upon the various embodiments of the gaming system. In some cases, a game will use just one video display 41. In such a case, the other displays, if present, may be used for advertisements, announcements, and other sequences of video images designed to obtain and keep the interest of game players. In other embodiments, a game may display sequences of video images upon two or more video display units 41-43. In such cases, the advertisements, announcements, and other sequences of video images may still be displayed upon any video display unit in which game related images are not being displayed.

The distinction between video display units used to display game related images and video display units used to display other images applies to all multi-panel gaming system regardless of how many video display units are present in the system. If a particular game uses all of the video display units 41-43 present in the system, the advertisements, announcements, and other sequences of video images may still be displayed upon the video display units when a player is not actively using the system.

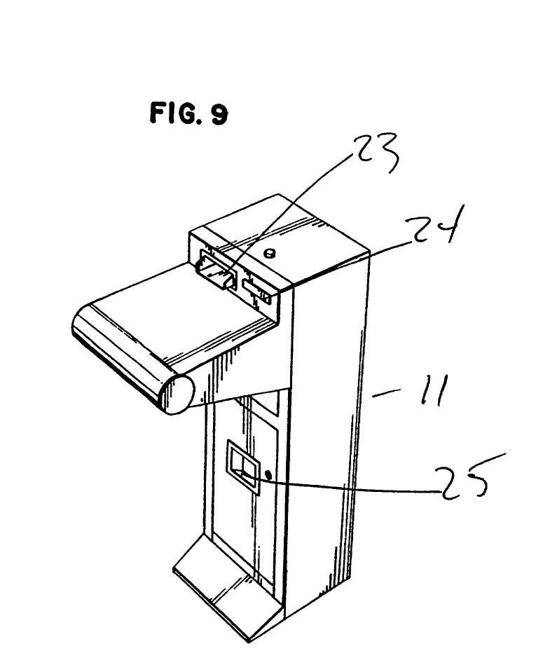

FIG. 9 illustrates a perspective view of the wager and prize unit having a coin return hopper according to another embodiment of the present invention. In embodiments in which wagering is permitted, the wager and prize unit 11 typically includes a bill, coin/token or credit card input device 23-24 that allows a player to add currency to a currently active banked amount. The wager and prize unit 11 also has a coin return hopper 25 that permits winnings in the form of coins, tokens, and similar items of value to be returned by the gaming system when a player has won an outcome of a game. This hopper 25 may return the winnings after the end of each game outcome. This hopper 25 may also maintain a banked amount within the computing system 110 to which winnings are added and from which wagers are deducted. In the latter embodiment, the hopper 25 returns winnings to a player when instructed by a player at the conclusion of a session of plays of the game.

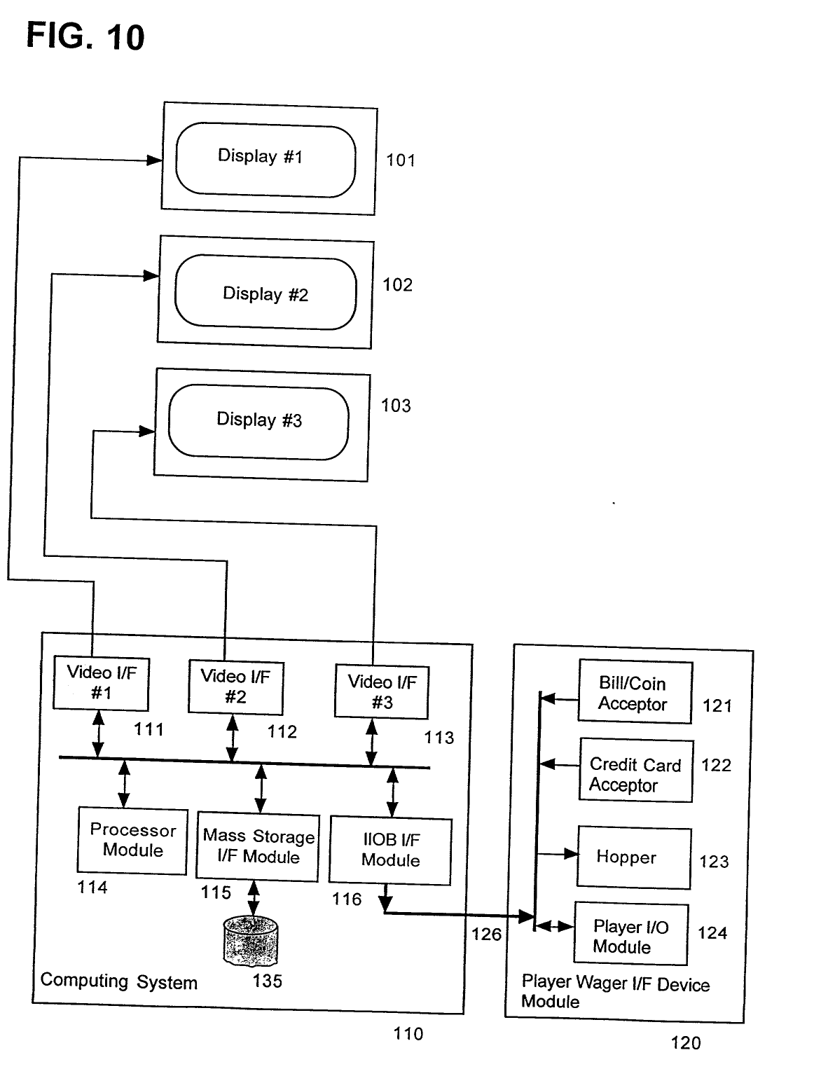

FIG. 10 illustrates a computing system used to generate the video images displayed upon the video display devices according to one embodiment of the present invention. The system includes a computing system 110, a player wager interface device module 120, and a plurality of video display devices 101-103. The computing system 110 is a programmable computer having a programmable processing module 114, a mass storage interface module 115 connected to a mass storage device 135, an IIOB interface module, and a video interface module 111-113 corresponding to each of the video display devices in the present embodiment of the system.

The computing system is constructed using a personal computer or similar industry standard computing system. The processing modules may be constructed using a microprocessor such as ones manufactured by Intel or Motorola. The mass storage devices may be any memory device capable of storing computer readable data and programs for use by the gaming system. In a preferred embodiment, the mass storage device is a CD-ROM drive and its corresponding interface module needed to connect the storage device 135 to the processing module 114 over a system bus. The technical description of a CD-ROM based mass storage system may be found in detail in a co-pending U.S. patent application, entitled, System and Method for Verifying the Contents of a Mass Storage Device Before Granting Access to Computer Readable Data Stored on the Device, Ser. No. 09/396,821, filed Sep. 14, 1999, which is concurrently assigned with the present application and is incorporated by reference in its entirety herein.

The IIOB module provides a programmable interface to the wager and prize unit 11 and the player interface modules contained therein. These modules include a bill/coin acceptor module 121, a credit card acceptor, 122, a hopper, 123 and a player I/O module. The technical description of these computer controlled gaming machines may be found in detail in co-pending U.S. patent application, entitled, Method and Apparatus for Providing a Compartmentalized Game Instruction Architecture within a Gaming Machine, Ser. No. 09/396,190, filed Sep. 14, 1999, that is commonly assigned and is incorporated by reference in its entirety herein. and in co-pending U.S. patent application, entitled, System and Method of Distributing Casino Games, Employing Platform Independent Programming and Common Communications Protocols, Ser. No. 60/153,718, filed Sep. 14, 1999, which is also concurrently filed with the present application and is also incorporated by reference in its entirety herein.

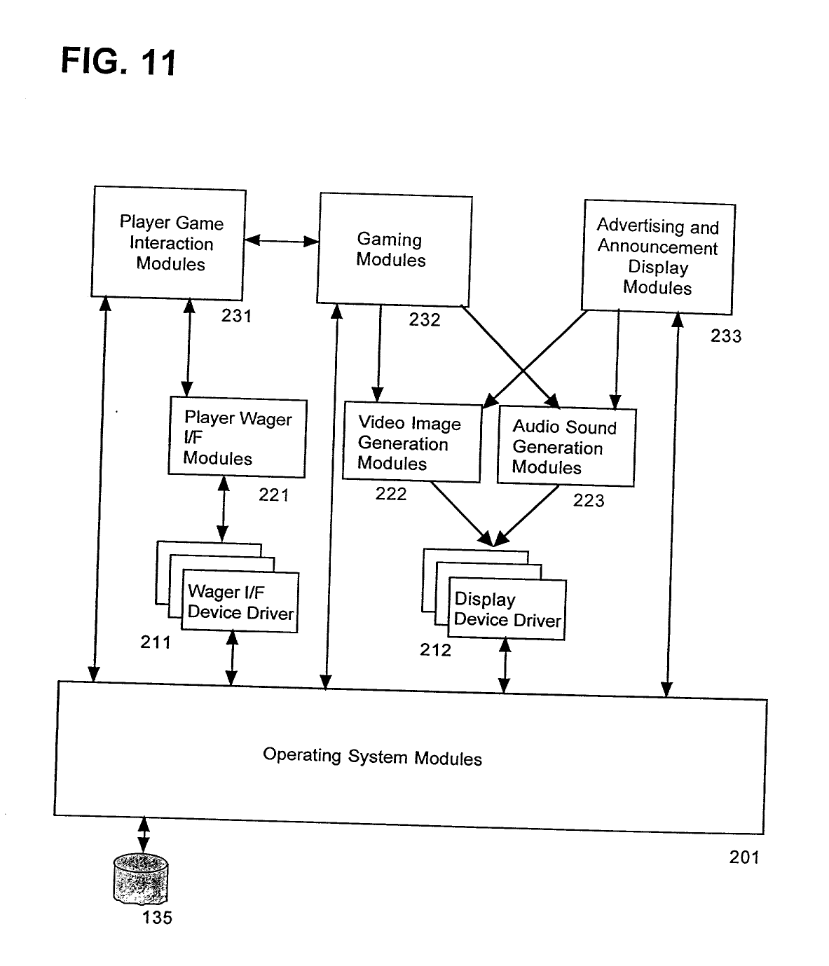

FIG. 11 illustrates a set of software modules executing within a computing system used to generate the video images displayed upon the video display devices according to another embodiment of the present invention. The software consists of an operating system 201, display device drivers 212, and wager interface device drivers 211. These modules together provide the basis operation of the computing system.

The software in the computing system includes game specific modules that are used to implement games and related images and gaming machine modules that are used to interface the gaming modules with the hardware devices and their supporting driver modules. The game specific modules include player game interaction modules 231, gaming modules 232 and advertisement and announcement display modules 233. The gaming machine modules video image generation modules, audio sound generation modules, and player wager interface modules.

The software for one such gaming system is disclosed within U.S. patent application, entitled, System and Method of Distributing Casino Games, Employing Platform Independent Programming and Common Communications Protocols, Ser. No. 60/153,718, filed Sep. 14, 1999, which is also concurrently assigned with the present application and is also incorporated by reference in its entirety herein, and

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An electronic gaming system for permitting a player to operate a video-based game, the gaming system comprising:
a programmable computing system enclosed within a computer enclosure having a top side and a back side;
a player wager and prize unit having a plurality of input and output devices relating to accepting wagers from the player and paying winnings to the player, the input and output devices are enclosed within the wager and prize unit;
a pair of vertical support members extending upward from the top side of the computer enclosure; and
two or more player display devices for presenting video images and audio sounds generated by the programmable computing system to the player, the player display devices having a pair of vertical edges and a pair of horizontal edges;
wherein the display devices are coupled to a pair of vertical support members about the vertical edges of the player display devices; and
the computer enclosure and the wager and prize unit are separate units electrically connected by a communication cable in order to permit the wager and prize unit to be easily be connected and disconnected from the computer enclosure.

2. The electronic gaming system according to claim 1, wherein the programmable computing system comprises:
a processing module electrically connected to a system bus;
two or more video interface modules connected to the system bus, each video display module is electrically connected to a player display device;
mass storage interface module connected to the system bus; and
an intelligent input and output module (IIOB) connected to the system bus;
wherein the IIOB module is further connected to the communications cable used to transmit and receive data to and from the wager and prize unit.

3. The electronic gaming system according to claim 1, wherein the wager and prize unit comprises one or more player interface units chosen from the following: a coin return hopper, a bill acceptor unit, a coin/token acceptor unit, a credit card acceptor unit, and a prize ticket payout unit.

4. The electronic gaming system according to claim 1, wherein the video display modules comprise an LCD panel for displaying video images.

5. The electronic gaming system according to claim 4, wherein the wherein the video display modules comprise one or more audio speakers.

6. The electronic gaming system according to claim 2, wherein the wherein the video interface modules comprise a video buffer memory module.

7. The electronic gaming system according to claim 2, wherein the programmable computing system comprise one or more concurrently operating software modules that generate the sequence of video images stored within the video interface modules for display upon the video display devices.

8. The electronic gaming system according to claim 7, wherein the sequence of video images comprise video images used to display games images presenting the operation of the game to the player.

9. The electronic gaming system according to claim 8, wherein the sequence of video images further comprise video images used to display advertisements and announcements.

10. The electronic gaming system according to claim 9, wherein the game images are displayed upon different video display devices from video display devices displaying the advertisements and announcements.

11. The electronic gaming system according to claim 3, wherein the communications cable electrically connecting the IIOB module to the wager and prize unit comprises a plurality of electrical connections to connect each of the one or more player interface units in the wager and prize unit to the IIOB module.

12. The electronic gaming system according to claim 11, wherein each of the one or more player interface units operate in response to commands received from and transmitted through the IIOB module to the processing module, the commands are processed by software modules executing within the processing module.

13. The electronic gaming system according to claim 7, wherein the software modules generate the sequence of video images based upon video data elements retrieved from mass storage devices connected to the mass storage interface module.

14. The electronic gaming system according to claim 13, wherein the video data elements retrieved from mass storage devices connected to the mass storage interface module comprise streaming video data transmitted directly from the mass storage interface module to the video display interface module.

15. A gaming apparatus, comprising:
a computer controlled gaming device including a payment receiver;
a computer controlled actuator;
a computer controlled determiner awarding winning for selected plays;
a computer controlled distributor for paying or crediting winnings; and
a display assembly mounted to the gaming device, the display assembly including a plurality of display screens providing gaming information;
wherein the screens are vertically connected in a serial configuration.

16. A gaming apparatus according to claim 15, wherein the display screens extend upward from the gaming device.

17. A gaming apparatus according to claim 15, wherein the plurality of display screens face toward a center point forward and above the gaming device.

18. A gaming apparatus according to claim 15, wherein the display comprises at least three screens.

19. A gaming apparatus according to claim 15, wherein the display screens comprise video screens for displaying computer generated video images.

20. A gaming apparatus according to claim 15, wherein the display screens mount on support rails on support rails, wherein a support rail extends upward from each end of the display screens.

21. A gaming apparatus according to claim 17, wherein the display screens mount on support rails on support rails, wherein a support rail extends upward from each end of the display screens.

22. A gaming apparatus according to claim 21, wherein the support rails arc about a radius having a focal point substantially at the center point.

23. A gaming apparatus according to claim 15, wherein the gaming device comprises a plurality of modules interconnecting in a side by side configuration.

24. A gaming apparatus according to claim 15, wherein adjacent display screens are connected at an oblique angle to one another.

25. A gaming apparatus according to claim 15, wherein the display screens display portions of a larger image that form a continuous image.

26. A gaming apparatus according to claim 15, further comprising gaming device controls, wherein the controls are located on an upper portion of the gaming device.

27. A display system for a computer controlled gaming apparatus having a housing, comprising:
a plurality of video display screens mounted to an upper portion of the housing;
wherein the display screens are connected along upper and lower edges to adjacent display screens.

28. A display system according to claim 27, wherein each of the display screens comprises a computer generated video display.

29. A display system according to claim 27, wherein the display system includes at least three connected display screens.

30. A display system according to claim 27, wherein the display screens are arranged at an obtuse angle to one another.

31. A display system according to claim 27, wherein the display screens are arranged to face a center point forward of the screens and above the housing.

32. A display system according to claim 31, wherein the display screens mount on arcing side rails, arcing about the center point.
